(19) United States
(12) Patent Application Publication
(10) Pub. No.: US 2026/0001113 A1
(43) Pub. Date: Jan. 1, 2026

(54) METHOD OF HEAVY METAL STABILIZATION IN SOIL USING SEQUESTRATION OF HEAVY METALS VIA REPETITIVE IN SITU IRON OXIDE SYNTHESIS

(71) Applicant: SEOUL NATIONAL UNIVERSITY R&DB FOUNDATION, Seoul (KR)

(72) Inventors: Kyoungphile NAM, Seoul (KR); Hosub LEE, Seoul (KR); Juyeop KIM, Seoul (KR); Kwangjin PARK, Incheon (KR)

(21) Appl. No.: 19/185,093

(22) Filed: Apr. 21, 2025

(30) Foreign Application Priority Data
Jun. 28, 2024 (KR) 10-2024-0085692

(51) Int. Cl. B09C 1/08; B09C 1/00

(52) U.S. Cl. CPC B09C 1/08; B09C 1/002; B09C 2101/00

(57) ABSTRACT

The present invention relates to a method of heavy metal stabilization in heavy metal contaminated soil, in which “in situ iron oxide synthesis” in which iron chloride hydrate is injected into the heavy metal contaminated soil, and heavy metals to be stabilized are leached into pores, to generate iron oxide in the heavy metal contaminated soil, is repeated multiple times, the in situ iron oxide synthesis is repeated while a predetermined period of rest time is provided between the in situ iron oxide synthesis each time, thereby exhibiting a very excellent heavy metal stormwater leaching reduction effect.

### CROSS REFERENCE TO RELATED APPLICATION

The present application claims priority to Korean Patent Application No. 10-2024-0085692, filed on June 28, 2024, the entire contents of which are hereby incorporated by this reference.

### BACKGROUND OF THE INVENTION

### FIELD OF THE INVENTION

The present invention relates to a method of heavy metal stabilization in soil.

### [Description of Government-Sponsored Research]

This invention was carried out with the support of Ministry of Environment under a research project of Unique Project identification number: 1485019611 and Project identification number: 00220404 titled “Feasibility study on in situ repetitive synthesis of iron oxides for stabilizing heavy metal-contaminated soil beneath a facility” managed by the Korea Environmental Industry & Technology Institute from April 1 to December 31, 2023.

This invention was also carried out with the support of Ministry of Environment under a research project of Unique Project identification number: 248000009 and Project identification number: 00220406 titled “Field demonstration of Unsaturated Large Soil Heavy Metal Location Stabilization Using Radial Double Horizontal Tube” managed by the Korea Environmental Industry & Technology Institute from January 1, 2024 to June 30, 2025.

### DESCRIPTION OF THE RELATED ART

Soil contaminated with heavy metals (hereafter referred to as ‘heavy metal contaminated soil’) requires remediation. Korean Registered Patent No. 10-2086955 describes a very useful technology for stabilizing arsenic-contaminated soil using coprecipitation of amorphous iron oxide and arsenic. However, these prior art technologies are not sufficient for stabilization or remediation of heavy metals in soil.

### SUMMARY OF THE INVENTION

The present invention provides a technology that can stabilize heavy metals in soil by physical and chemical co-sequestration, thereby significantly reducing the leaching degree of heavy metal from the soil due to stormwater, i.e., showing great efficacy in metal immobilization. In particular, the purpose of present invention is to provide a technology that can effectively stabilize cadmium in the soil and sufficiently suppress stormwater leaching.

The present invention provides a method of heavy metal stabilization in heavy metal contaminated soil, the method including: a first in situ iron (Fe) oxide synthesis step (step S1) of injecting iron chloride hydrate into heavy metal contaminated soil to synthesize iron oxide; a first rest step (step S2) of leaving the heavy metal contaminated soil in which the first in situ iron oxide synthesis is performed in an equilibrium state; a second in situ iron oxide synthesis step (step S3) of injecting iron chloride hydrate into the heavy metal contaminated soil to synthesize iron oxide; and a second rest step (step S4) of leaving the heavy metal contaminated soil in which the second in situ iron oxide synthesis is performed in an equilibrium state.

In the method of heavy metal stabilization in heavy metal contaminated soil according to the present invention, in situ iron (Fe) oxide synthesis is repeated multiple times. At this time, in situ iron oxide synthesis is repeated while a predetermined period of rest time is provided between respective times of in situ iron oxide synthesis. This results in an excellent heavy metal stormwater leaching reduction.

In particular, in the present invention, when in situ iron oxide synthesis is performed, iron chloride hydrate is injected into the heavy metal contaminated soil, and the Fe injection amount is adjusted to be optimal. Furthermore, in the present invention, the pH of the heavy metal contaminated soil into which iron chloride hydrate is injected is optimized. Therefore, the heavy metal stormwater leaching reduction effect can be further maximized.

### BRIEF DESCRIPTION OF THE DRAWINGS

FIG. 1 is a schematic flowchart showing a sequence of a method of heavy metal stabilization in heavy metal contaminated soil according to the present invention.

FIG. 2 is a schematic flowchart showing respective steps performed sequentially in in situ iron oxide synthesis of the present invention.

FIG. 3 is a graph diagram of a cadmium concentration in a leachate measured for samples with different forms of heavy metals in the contaminated soil.

FIG. 4 is a graph diagram of the cadmium concentration in the leachate measured for samples with different numbers of repetitions of the in situ iron oxide synthesis according to the present invention.

FIG. 5 is a graph diagram of a pH values measured for contaminated soil samples with different injection amounts of OH⁻.

FIG. 6 is a graph diagram of a measurement value of cadmium leached in a supernatant for contaminated soil samples with different injection amounts of OH⁻.

FIG. 7 is a graph diagram of a cadmium mass according to the pH value of the contaminated soil.

FIGS. 8 and 9 are graph diagrams of cadmium concentrations in leachates measured for samples subjected to in situ iron oxide synthesis with different periods of rest time, respectively.

FIG. 10 is a distribution diagram of EMPA-EDS measurements for iron oxide according to the in situ iron oxide synthesis once.

FIG. 11 is a distribution diagram of EMPA-EDS measurements for iron oxide according to the in situ iron oxide synthesis twice.

### DETAILED DESCRIPTION OF THE PREFERRED EMBODIMENTS

The method of heavy metal stabilization in heavy metal contaminated soil according to the present invention includes “repetitive in situ iron (Fe) oxide synthesis”. ”In situ Fe oxide synthesis” is a process for injecting iron chloride hydrate into heavy metal contaminated soils, and therefore creating iron oxide in place, or in situ, to stabilize metals and metalloids in soil. In the present invention, the in situ iron oxide synthesis is repeated, and a rest step for taking a predetermined period of rest time between respective times of in situ iron oxide synthesis is provided. The heavy metals targeted for stabilization in the present invention are cadmium, arsenic, zinc, and the like. The present invention has a very useful effect in stabilizing cadmium. In the description below, the present invention describes illustrating “cadmium (Cd)” as an example of the heavy metal targeted for stabilization.

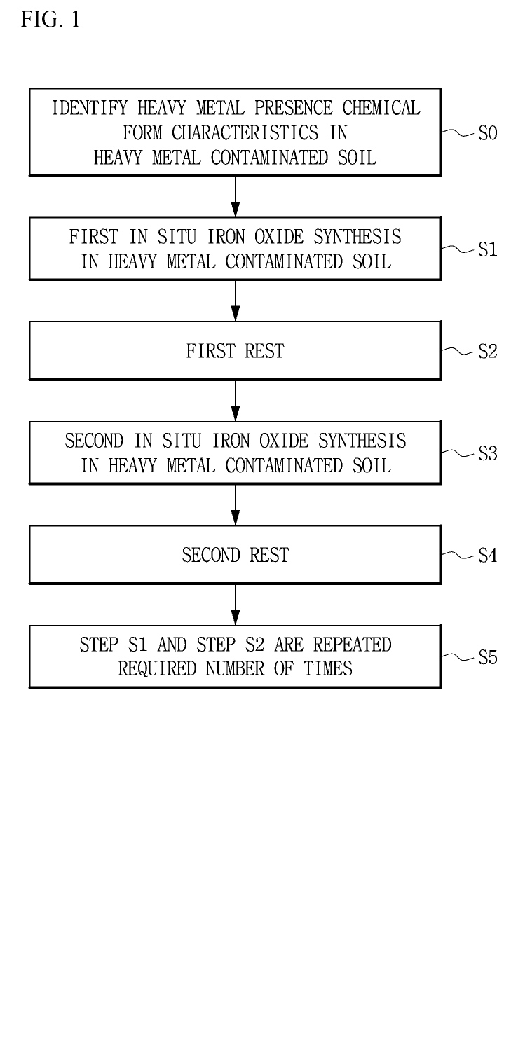

FIG. 1 is a schematic flowchart showing a sequence of a method of heavy metal stabilization in heavy metal contaminated soil according to the present invention. The method of heavy metal stabilization in the heavy metal contaminated soil includes the following steps:

(1) a first in situ iron oxide synthesis step in heavy metal contaminated soil (step S1) which is performing a first in situ iron oxide synthesis;

(2) a first rest step (step S2); and

(3) a second in situ iron oxide synthesis step in the heavy metal contaminated soil (step S3) which is performing a second in situ iron oxide synthesis.

In the method of heavy metal stabilization in the heavy metal contaminated soil according to the present invention, a first in situ iron oxide synthesis step is performed, followed by a rest step for a predetermined period of rest time, and subsequently second in situ iron oxide synthesis step is performed.

In the method of heavy metal stabilization in the heavy metal contaminated soil according to the present invention, only such the in situ iron oxide synthesis step may be performed two times. However, in the present invention, the in situ iron oxide synthesis step may be repetitively performed for a plurality of times such as three, four, or five or more times, if necessary. In the present invention, after performing each round of the in situ iron oxide synthesis step, the “rest step” is necessarily performed. Therefore, the additional second rest step (step S4) is performed after above step S3 is performed, and subsequently a further step (step S5) repeats above step S1 and step S2 for the required number of times. For example, when three in situ iron oxide synthesis steps are performed, a second in situ iron oxide synthesis step (a second in situ iron oxide synthesis) is performed, followed by a second rest step, and then a third in situ iron oxide synthesis step (third in situ iron oxide synthesis) is performed.

In this manner, in the method of heavy metal stabilization in heavy metal contaminated soil according to the present invention, the in situ iron oxide synthesis in the heavy metal contaminated soil is repeated multiple times. Then, while a predetermined period of rest time is taken between respective times of in situ iron oxide synthesis, the in situ iron oxide synthesis is repeated. The “rest step” performed between the in situ iron oxide synthesis in the present invention means leaving the heavy metal contaminated soil with performing no actions for a predetermined period of rest time. During this “rest step”, actions for preventing additional water from flowing into the heavy metal contaminated soil or actions for preventing water from evaporating from the inside of the contaminated soil can be actively taken.

The stormwater leaching reduction effect of heavy metals according to the in situ iron oxide synthesis may vary depending on the “nature of the chemical forms of heavy metals in the contaminated soil”. In general, cadmium in the contaminated soil may be present in the form of “a Fe/Mn oxide bound”. Cadmium may also be present in the contaminated soil in the form of “residual” or in the form of “ion-exchangeable”. The method according to the present invention has a very excellent heavy metal stormwater leaching rate reduction effect for contaminated soil in which cadmium is present in the form of “ion-exchangeable”. Therefore, before insitu iron oxide synthesis in heavy metal contaminated soil is repeated for a plurality of times as described above, it is necessary to identify the forms of heavy metals in the heavy metal contaminated soil. It is necessary to further perform a step for examining whether soil is contaminated with heavy metals in the form of “ion-exchangeable”. Therefore, in the method of heavy metal stabilization in the heavy metal contaminated soil according to the present invention, prior to the step for first in situ iron oxide synthesis in the heavy metal contaminated soil (step S1) is performed, a step for identifying the forms of the heavy metals in the heavy metal contaminated soil and examining whether soil is contaminated with heavy metals in the form of “ion-exchangeable” (step S0).

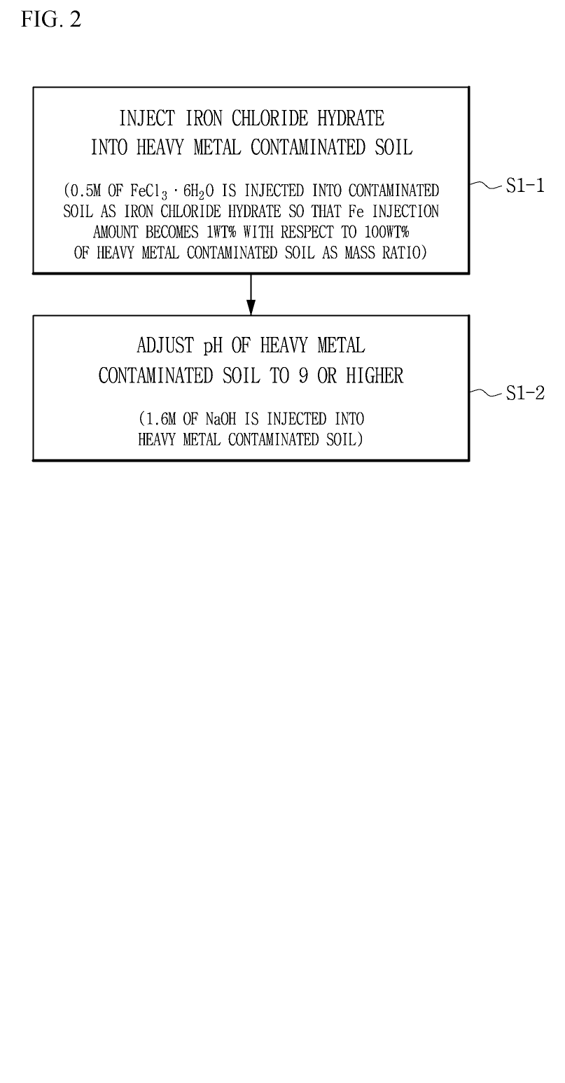

In the method of heavy metal stabilization in the heavy metal contaminated soil according to the present invention, unlike the prior art, in situ iron oxide synthesis is achieved by sequentially performing the following special processes. FIG. 2 is a schematic flowchart showing respective steps sequentially performed in the insitu iron oxide synthesis of the present invention. As depicted in FIG. 2, the “in situ iron oxide synthesis” of the present invention includes a step for injecting iron chloride hydrate into the heavy metal contaminated soil (step S1-1); and a step for adjusting the pH of the heavy metal contaminated soil to 9 or higher (step S1-2). When iron chloride hydrate is injected into the heavy metal contaminated soil, the heavy metal to be stabilized (specifically, cadmium) present in the contaminated soil leaches into pores and reacts with iron chloride hydrate, thereby generating iron oxide in the heavy metal contaminated soil. The generation of iron oxide results in chemical sequestration (incorporation) of the heavy metals. Here, “chemical sequestration” means a stabilization mechanism in which the heavy metals occupy vacancy within the unique crystal structure of iron oxide or ion-exchange with iron ions, resulting in the form of iron oxide containing foreign substances, that is, iron oxide entraps heavy metals, thereby sequestering heavy metals from environmental conditions that leaches heavy metals, such as stormwater percolation.

When a step for injecting iron chloride hydrate into the heavy metal contaminated soil in the “in situ iron oxide synthesis” of the present invention (step S1-1) is performed, it is preferable to use FeCl₃·6H₂O as iron chloride hydrate. In this case, it is necessary to inject FeCl₃·6H₂O so that the Fe injection amount becomes 1% with respect to 100% by mass of the heavy metal contaminated soil as a mass ratio. Therefore, in a specific embodiment of the present invention, in the above step S1-1, it is preferable to inject iron chloride hydrate into the heavy metal contaminated soil so that the Fe injection amount is 1 wt% with respect to the total 100 wt% of the heavy metal contaminated soil as a mass ratio. It is preferable to use FeCl₃·6H₂O as the iron chloride hydrate, but the present invention is not limited thereto.

Meanwhile, in the “in situ iron oxide synthesis” of the present invention, after iron chloride hydrate is injected into the heavy metal contaminated soil, the pH of the heavy metal contaminated soil is adjusted to be 9 or higher (step S1-2). In step S1-2, NaOH can be injected into the heavy metal contaminated soil in order to cause the pH of the heavy metal contaminated soil into which iron chloride hydrate is injected to be 9 or higher.

Such step S1-1 and step S1-2 are carried out sequentially for the heavy metal contaminated soil, the “in situ iron oxide synthesis” of the present invention is performed. As iron oxide is thus generated in the heavy metal contaminated soil, heavy metals are chemically sequestered and stabilized, and accordingly the phenomenon of leaching heavy metals from the contaminated soil during stormwater percolation is extremely suppressed. That is, a highly desirable effect of greatly reducing the heavy metal stormwater leaching is exhibited.

In the method of heavy metal stabilization in the heavy metal contaminated soil according to the present invention, the in situ iron oxide synthesis according to the present invention is repeated “multiple times”. That is, the repetition is performed two or more times. However, the in situ iron oxide synthesis is not continuously performed without a break, but the in situ iron oxide synthesis is repeated with interposing the “rest step” for leaving the heavy metal contaminated soil with taking no additional actions other than the action of preventing the inflow of stormwater during a predetermined period of rest time between respective times of in situ iron oxide synthesis. In the present invention, by providing such a rest step between respective times of the in situ iron oxide synthesis, iron oxide is formed in the heavy metal contaminated soil so that heavy metals are strongly either adsorbed and sequestered on/in to the iron oxide, thereby the heavy metals can be sufficiently stabilized in the contaminated soil. Accordingly, the mobility of the heavy metals is greatly suppressed, and therefore a more excellent heavy metal stormwater leaching reduction effect can be exhibited. The rest time in the rest step in the present invention is preferably 12 hours or more, and the most preferable rest time is 12 hours. That is, it is most preferable that the in situ iron oxide synthesis is performed once, followed by having the rest time for leaving the contaminated soil for 12 hours (rest step), and a subsequent additional in situ iron oxide synthesis work is performed.

Hereinafter, the test for verifying the effect and advantages of the method of heavy metal stabilization in the heavy metal contaminated soil according to the present invention is described in detail.

### 1) Test for Verifying Heavy Metal Stormwater Leaching Reduction Effect according to Forms of Heavy Metals in Heavy Metal Contaminated Soil

The method according to the present invention has a very excellent stormwater leaching reduction effect on the contaminated soil in which cadmium is present in the form of “ion-exchangeable”. In order to verify the effect, the following test was performed.

### Test Target Soil

As soil contaminated with cadmium, samples were prepared for three types of soil with different forms of heavy metals in contaminated soil as follows.

- “Soil of Type A”: Cadmium was present in contaminated soil in a mixed manner in the form of “a Fe/Mn oxide bound”, and the concentration of cadmium in the contaminated soil was 560 mg/kg.

- “Soil of Type B”: Cadmium was present in contaminated soil in the form of “residual”, and the concentration of cadmium in the contaminated soil was 326 mg/kg.

- “Soil of Type C”: Cadmium was present in contaminated soil in the form of “ion-exchangeable”, and the concentration of cadmium in the contaminated soil was 33 mg/kg.

- “Soil of Type D”: Cadmium was present in contaminated soil in the form of “ion-exchangeable”, and the concentration of cadmium in the contaminated soil was 27 mg/kg.

Also, for each sample of the “soil of Type A”, the “soil of Type B”, the “soil of Type C”, and the “soil of Type D” above, one in which the in situ iron oxide synthesis of the present invention was not performed at all and the other in which the in situ iron oxide synthesis of the present invention was performed once were separately prepared. That is, for the “soil of Type A”, a sample in which the in situ iron oxide synthesis of the present invention was not performed at all and a sample in which the in situ iron oxide synthesis of the present invention was performed once were respectively prepared. The same applies to the “soil of Type B”, the “soil of Type C”, and the “soil of Type D”, respectively.

When the in situ iron oxide synthesis of the present invention for the sample of the contaminated soil was performed, FeCl₃·6H₂O was injected as iron chloride hydrate into the heavy metal contaminated soil, so that the Fe injection amount was 1 wt% with respect to 100 wt% of the heavy metal contaminated soil as a mass ratio. Therefore, after the injection of iron chloride hydrate, NaOH was injected, and the pH of the heavy metal contaminated soil was adjusted to 9. At this time, the concentration of FeCl₃·6H₂O was 0.5 M, and the concentration of NaOH was 1.6 M. Unless otherwise specified, the “in situ iron oxide synthesis” of the present invention was performed in the manner described above in the following contents.

When the in situ iron oxide synthesis was performed once on the prepared sample, after the in situ iron oxide synthesis was performed, the sample was left for 12 hours (rest time of 12 hours). After the elapse of the rest time of 12 hours, a standard stormwater simulation leaching test was performed. The well-known standard stormwater simulation leaching test was performed on each of the prepared samples of the heavy metal contaminated soil to measure the cadmium concentration in a leachate. Then, the chemical form of cadmium in the soil was confirmed using the Tessier sequential extraction method.

### Test Results and Comparison of Stormwater Leaching Reduction Effects

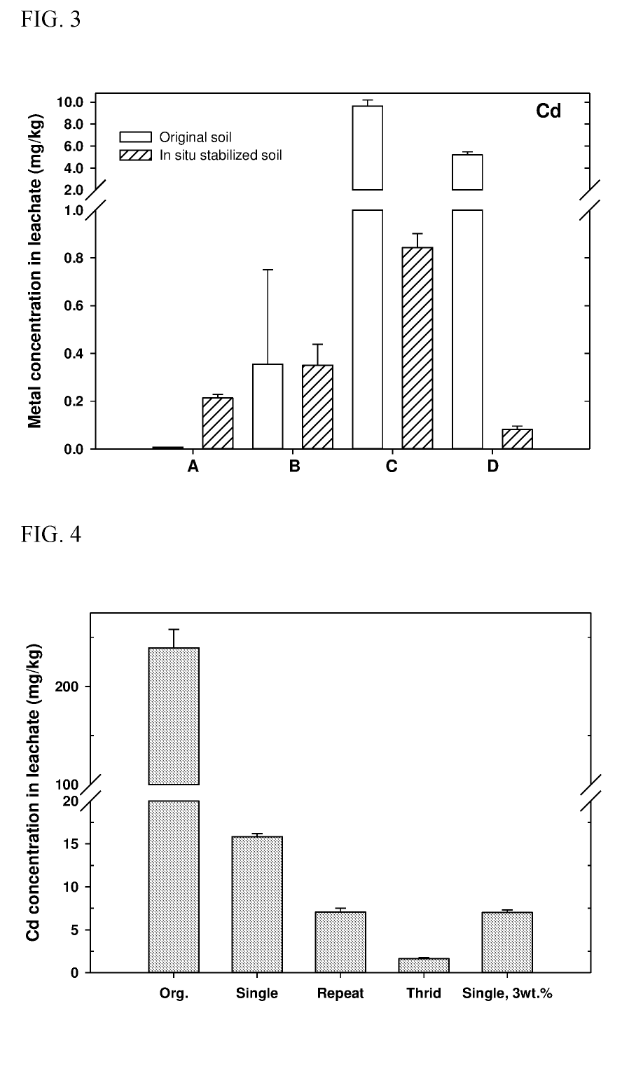

As described above, FIG. 3 depicts a graph diagram of a cadmium concentration in a leachate measured by performing a USEPA standard Synthetic Precipitation Leaching Procedure for samples with different forms of heavy metals in the contaminated soil. In the graph diagram of FIG. 3, parts described as “Original soil” (bar graphs without hatching) represent samples that were not subjected to the in situ iron oxide synthesis, respectively. In the graph diagram of FIG. 3, parts described as “In situ stabilized soil” (bar graphs with hatching) represent samples subjected to the in situ iron oxide synthesis according to the present invention once as described above, respectively. In addition, the vertical axis in the graph diagram of FIG. 3 represents <cadmium concentration in the leachate (Metal concentration in leachate) mg/kg>, and A on the horizontal axis represents the soil of Type A described above. In the graph diagram of FIG. 3, B represents the soil of Type B described above, and C and D represent the soil of Type C and the soil of Type D described above, respectively.

As seen from the results of FIG. 3, in the case of the soil of Type A where cadmium was present in the form of “a Fe/Mn oxide bound”, the soil subjected to the insitu iron oxide synthesis of the present invention showed a higher cadmium concentration in the leachate than the soil was not subjected to the in situ iron oxide synthesis. In the case of the soil of Type B where cadmium was present in the form of “residual”, the soil subjected to the in situ iron oxide synthesis of the present invention and the soil was not subjected to the in situ iron oxide synthesis showed almost the same cadmium concentration in the leachate. These test results ultimately show that the cadmium stormwater leaching reduction effect by the in situ iron oxide synthesis according to the present invention is minimal or rather negative for the soil of Type A and the soil of Type B.

Meanwhile, in the case of the soil of Type C and the soil of Type D where cadmium was present in the form of “ion-exchangeable” in the soil, the cadmium stormwater leaching reduction effect by the in situ iron oxide synthesis according to the present invention was very large and remarkably expressed. As seen in the graph diagram of FIG. 3, in the case of soil of Type C and soil of Type D where cadmium was present in the form of “ion-exchangeable” in the soil, the soil subjected to the in situ iron oxide synthesis of the present invention showed a significantly lower cadmium concentration in the leachate than the soil was not subjected to the in situ iron oxide synthesis. These results show that when cadmium was present in the form of “ion-exchangeable” in the in the contaminated soil, the in situ iron oxide synthesis according to the present invention has a very excellent stormwater leaching reduction effect.

In this manner, the stormwater leaching reduction effect by the in situ iron oxide synthesis of the present invention varies depending on form of the cadmium in the soil. Specifically, the in situ iron oxide synthesis according to the present invention has a more excellent stormwater leaching reduction effect in the case where cadmium is present in the soil in the form of “ion-exchangeable” than in the cases where cadmium is present in the soil in the form of “a Fe/Mn oxide bound” or cadmium is present in the soil in the form of “residual”. Therefore, when the method of heavy metal stabilization in the heavy metal contaminated soil of the present invention is performed, it is very preferable to perform a step for identifying the forms of heavy metals in the heavy metal contaminated soil and examining whether soil is the contaminated with heavy metals in the form of “ion-exchangeable” (step S0).

### 2) Test for Verifying Heavy Metal Stormwater Leaching Reduction Effect according to Repetitive in situ Iron Oxide Synthesis

A test was performed in order to check the heavy metal stormwater leaching reduction effect according to the in situ iron oxide synthesis of the present invention (the effect of reducing leaching of heavy metal due to stormwater) and check the increase of the heavy metal stormwater leaching reduction effect by the repetitive in situ iron oxide synthesis.

### Test Target Soil

Sand contaminated with cadmium in which cadmium was present in the contaminated soil in the form of “ion-exchangeable”, and the cadmium concentration in the contaminated soil was 337 mg/kg was selected as a test target heavy metal contaminated soil.

The samples for the test were prepared as follows.

1) A sample obtained by not performing the in situ iron oxide synthesis of the present invention at all on the test target heavy metal contaminated soil (Sample-Org.);

2) A sample obtained by performing the in situ iron oxide synthesis of the present invention once on the test target heavy metal contaminated soil (Sample-Single);

3) A sample obtained by performing the in situ iron oxide synthesis of the present invention twice on the test target heavy metal contaminated soil (Sample-Repeat);

4) A sample obtained by performing the in situ iron oxide synthesis of the present invention three times on the test target heavy metal contaminated soil (Sample-Third);

5) A sample obtained by performing the in situ iron oxide synthesis of the present invention once on the test target heavy metal contaminated soil with modified conditions for the in situ iron oxide synthesis (Sample-Single, 3wt%).

When the in situ iron oxide synthesis of the present invention is performed on each piece of the test target heavy metal contaminated soil, FeCl₃·6H₂O was injected into the heavy metal contaminated soil as iron chloride hydrate for the heavy metal contaminated soil so that the Fe injection amount was 1 wt% with respect to 100 wt% of the heavy metal contaminated soil as the mass ratio, and NaOH was injected as the injection of iron chloride hydrate so that the pH of the heavy metal contaminated soil was adjusted to 9.

Particularly, in the case of “Sample-Single”, the in situ iron oxide synthesis was performed only once, but the same was left for 12 hours after the in situ iron oxide synthesis once (the rest time of 12 hours), and the standard stormwater simulation leaching test was performed after the elapse of rest time.

In the case of “Sample-Repeat”, the same sample as in “Sample-Single” subjected to the in situ iron oxide synthesis once was left for the rest time of 12 hours, and then the second in situ iron oxide synthesis in which iron chloride hydrate (FeCl₃·6H₂O) was injected into the heavy metal contaminated soil as iron chloride hydrate so that the Fe injection amount was 1 wt% with respect to 100 wt% of the heavy metal contaminated soil as the mass ratio, and NaOH was injected so that the pH of the heavy metal contaminated soil was adjusted to 9 was additionally performed (the second in situ iron oxide synthesis was performed by the same method of the first in situ iron oxide synthesis). In the case of “Sample-Repeat”, the sample was left for 12 hours after the second in situ iron oxide synthesis was performed as above (the rest time of 12 hours), and then the standard stormwater simulation leaching test was performed.

The case of “Sample-Third” is heavy metal contaminated soil subjected to the in situ iron oxide synthesis three times. The “Sample-Third” is a sample obtained by performing the in situ iron oxide synthesis of the present invention once more on heavy metal contaminated soil subjected to the in situ iron oxide synthesis twice, that is, the same sample of the heavy metal contaminated soil as in “Sample-Repeat”. Specifically, FeCl₃·6H₂O was injected as iron chloride hydrate so that the Fe injection amount was 1 wt% with respect to 100 wt% of the heavy metal contaminated soil as the mass ratio on the sample of the heavy metal contaminated soil subjected to the in situ iron oxide synthesis twice, and NaOH was treated so that the pH of the heavy metal contaminated soil was adjusted to 9 (the third in situ iron oxide synthesis was performed) to prepare “Sample-Third”. Also, in the case of “Sample-Third”, the same was left for 12 hours (the rest time of 12 hours) after the third in situ iron oxide synthesis was performed, and then the standard stormwater simulation leaching test was performed. Specific contents of the in situ iron oxide synthesis of three times which were performed on “Sample-Third” were the same as the first in situ iron oxide synthesis performed before on “Sample-Single”.

“Sample-Single, 3wt%” is heavy metal contaminated soil subjected to the in situ iron oxide synthesis once, but unlike “Sample-Single”, when the in situ iron oxide synthesis was performed, the Fe injection amount was increased (increased so that the amount was 3 wt% with respect to 100 wt% of the heavy metal contaminated soil as the mass ratio). That is, like “Sample-Single” described above, the heavy metal contaminated soil was subjected to the in situ iron oxide synthesis once by injecting FeCl₃·6H₂O into the heavy metal contaminated soil as iron chloride hydrate, injecting NaOH after the injection of FeCl₃·6H₂O so that the pH of the heavy metal contaminated soil was 9, and causing the Fe injection amount to be 3 wt% with respect to 100 wt% of the mass of the heavy metal contaminated soil as the mass ratio, to prepare “Sample-Single, 3wt%”. Like the other samples described above, “Sample-Single, 3wt%” was also left for 12 hours (the rest time of 12 hours) after thein situ iron oxide synthesis, to perform the standard stormwater simulation leaching test.

### Test Results and Comparison of Stormwater Leaching Reduction Effects

FIG. 4 depicts a graph diagram of the cadmium concentration in the leachate measured by performing a well-known standard stormwater simulation leaching test for each of “Sample-Org.”, “Sample-Single”, “Sample-Repeat”, “Sample-Third”, and “Sample-Single, 3wt%”. The vertical axis in the graph diagram of FIG. 4 represents <cadmium concentration in the leachate mg/kg>, and <Org.> on the horizontal axis represents “Sample-Org.” above. In the graph diagram of FIG. 4, <Single> represents “Sample-Single” subjected to the in situ iron oxide synthesis once, and <Repeat> represents “Sample-Repeat” subjected to the in situ iron oxide synthesis twice. Also, in the graph diagram of FIG. 4, <Third> represents “Sample-Third” subjected to the in situ iron oxide synthesis three times, and <Single, 3wt%> represents “Sample-Single, 3wt%”.

As shown in FIG. 4, the heavy metal stormwater leaching amounts from the heavy metal contaminated soil were measured for 239.3 mg/kg for “Sample-Org.”, 15.8 mg/kg for “Sample-Single”, 7.1 mg/kg for “Sample-Repeat”, 1.6 mg/kg for “Sample-Third”, and 7.0 mg/kg for “Sample-Single, 3wt%”. Such test results showed that heavy metal stormwater leaching reduction effects also increased in proportion to the number of times (repetition times) of in situ iron oxide synthesis for the heavy metal contaminated soil. According to the increase of the repetition times of the in situ iron oxide synthesis of the present invention, the amount of cadmium chemically or physically sequestered in the iron oxide generated by the synthesis increases, and accordingly, the leaching amount of heavy metal decreases, so that the resulting heavy metal stormwater leaching reduction effect is determined to be greater.

Particularly, when “Sample-Third” and “Sample-Single, 3wt%” were compared, even though the Fe injection amounts in the heavy metal contaminated soil were the same (the total Fe injection amount of 3 wt% with respect to 100 wt% of the mass of the heavy metal contaminated soil with respect to the mass ratio), it was confirmed that “Sample-Third” subjected to the in situ iron oxide synthesis more times (three times) showed a more excellent heavy metal stormwater leaching reduction effect than “Sample-Single, 3wt%” subjected to the in situ iron oxide synthesis only once. This confirms that, even if the in situ iron oxide synthesis is performed so that the Fe injection amount is the same, it is more preferable to repetitively perform the in situ iron oxide synthesis as in the present invention. Through the test result, it can be confirmed that the repetitive in situ iron oxide synthesis according to the present invention has a very excellent effect in heavy metal stormwater leaching reduction.

### 3) Test for Verifying Heavy Metal Leaching Amount in the soil solution depending on pH of Soil

The following test was performed as follows in order to verify the influence of the pH of the soil in the in situ iron oxide synthesis of the present invention.

### Test Target Soil

In order to confirm the influence depending on pH of the soil, as the soil contaminated by cadmium, contaminated soil in which cadmium was present in the contaminated soil in the form of “ion-exchangeable” and the cadmium concentration in the form of ion-exchangeable was 23.5 mg/kg, and contaminated soil in which the cadmium concentration in the form of ion-exchangeable was 18.7 mg/kg were prepared as samples of the test target soil, respectively. With respect to all the prepared samples of the heavy metal contaminated soil, the in situ iron oxide synthesis was performed once in which FeCl₃·6H₂O was injected into the heavy metal contaminated soil as the iron chloride hydrate so that the Fe injection amount became 1% with respect to the mass of the heavy metal contaminated soil as the mass ratio, and NaOH was injected so that the pH of the heavy metal contaminated soil was adjusted to 9, then the resultant was left for 12 hours, and a USEPA standard Synthetic Precipitation Leaching Procedure was performed, to measure the cadmium concentration in the leachate. However, as the method of changing the pH of the soil, NaOH was injected into the heavy metal contaminated soil (the concentration of NaOH at this time was 1.6 M), and the injection amounts of OH⁻ were different for each sample of the heavy metal contaminated soil. Specifically, the injection amounts of OH⁻ (Unit OH⁻ mol/kg) were made different from each other as 0.0, 0.1, 0.3, 0.4, 0.5, 0.7, 0.8, 0.9, and 1.1.

### Test Results and Comparison of Stormwater Leaching Reduction Effects

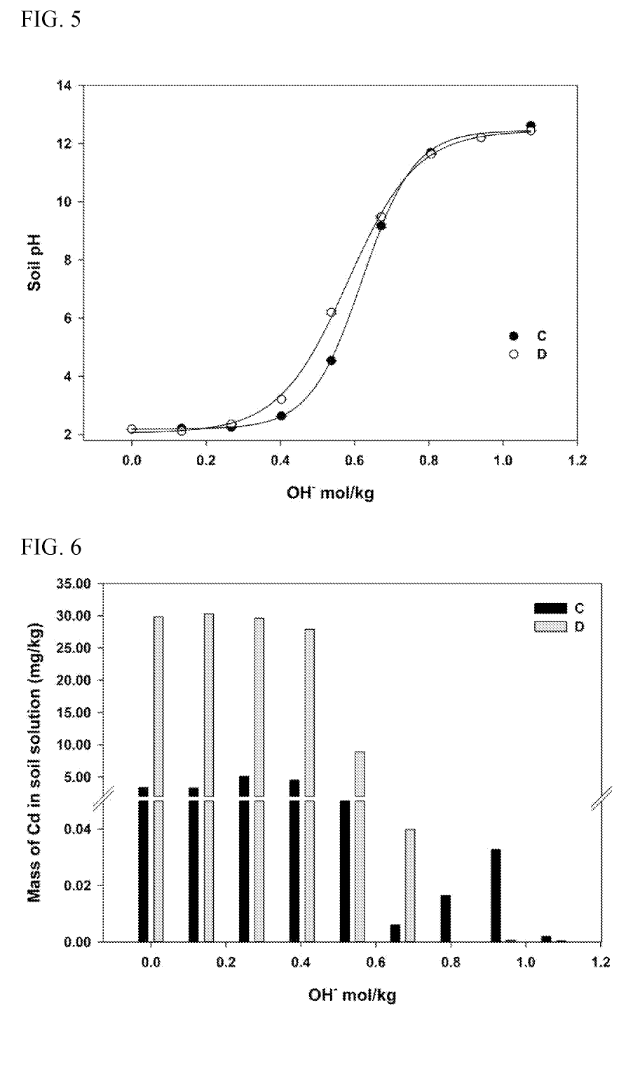

With respect to the prepared samples of the heavy metal contaminated soil, the pH of the soil was measured, and results thereof were shown in the graph diagram of FIG. 5. The horizontal axis in the graph diagram of FIG. 5 represents the injection amount of OH⁻ for each sample of the contaminated soil (Unit OH⁻ mol/kg), and the vertical axis represents the pH measurement value of the soil (Soil pH). Also, C in FIG. 5 means a sample in which the cadmium concentration in the form of ion-exchangeable is 23.5 mg/kg (for convenience, referred to as <C-soil>), and D means a sample in which the cadmium concentration in the form of ion-exchangeable is 18.7 mg/kg (for convenience, referred to as <D-soil>).

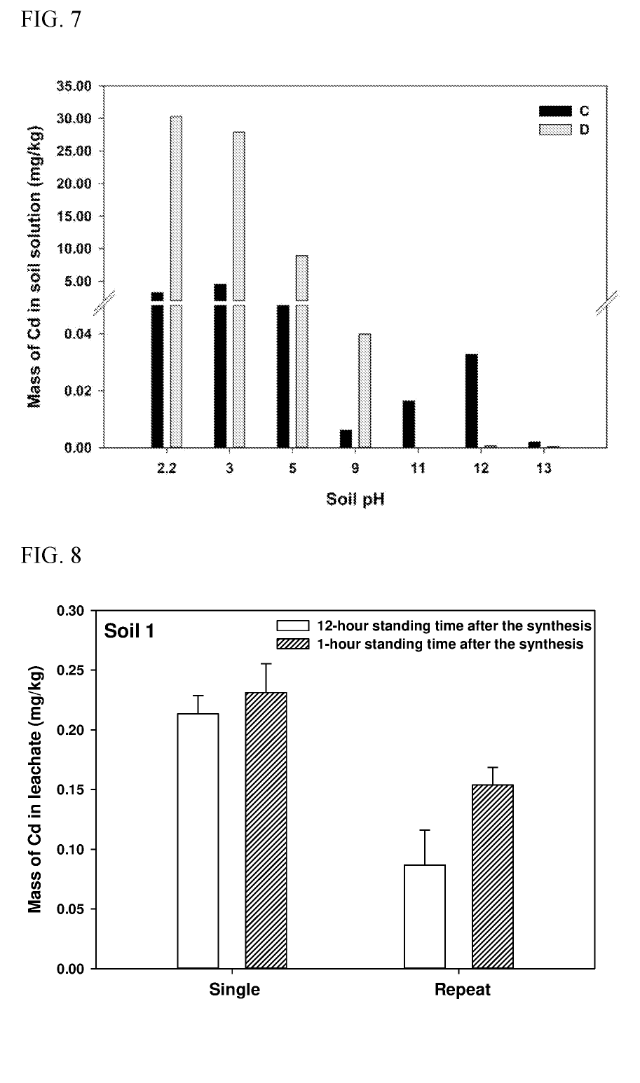

Also, each sample of the heavy metal contaminated soil was placed in distilled water, and the amount of cadmium leached into the distilled water in which the sample was placed, that is, the supernatant, was measured and compared. The measurement results of the cadmium amount are shown in FIGS. 6 and 7. FIG. 6 is a graph diagram of the cadmium mass depending on the injection amount of OH⁻, and FIG. 7 is a graph diagram of the cadmium mass depending on the pH value of the contaminated soil. In FIG. 6, the horizontal axis represents the injection amount of OH⁻ for each sample of the contaminated soil as in FIG. 5 (Unit OH⁻ mol/kg), and the vertical axis represents the mass of cadmium with respect to the supernatant (unit mg/kg). The horizontal axis in FIG. 7 represents the pH value of the heavy metal contaminated soil, and the vertical axis represents the mass of cadmium with respect to the supernatant (unit mg/kg). The meanings of C and D shown in FIGS. 6 and 7 are the same as those in FIG. 5.

As shown in FIGS. 5 to 7, it was confirmed that cadmium leached from <C-Soil> and <D-Soil> was reduced to 1 mg/kg or less, only when the injection amount of OH⁻ was 0.7 OH⁻ mol/kg or more when NaOH was injected into heavy metal contaminated soil for the in situ iron oxide synthesis once. Particularly, as shown in FIG. 5, when the injection amount of OH⁻ was 0.7 OH⁻ mol/kg, the pH of the heavy metal contaminated soil became 9, and if the injection amount of OH⁻ was further increased, the pH of the heavy metal contaminated soil was accordingly increased to exceed 9. This result confirms that, in order to exhibit a meaningful and effective heavy metal stormwater leaching reduction, it is preferable to adjust the pH of the heavy metal contaminated soil to be 9 or more in the in situ iron oxide synthesis.

### 4) Test for Verifying Heavy Metal Stormwater Leaching Reduction Effect depending on Rest Time between in situ Iron Oxide Synthesis

In the in situ iron oxide synthesis a plurality of times in the method of heavy metal stabilization in the heavy metal contaminated soil of the present invention, after each time of the step for in situ iron oxide synthesis is performed, the rest step for taking a predetermined period of rest time (about 12 hours or 12 hours or more) is necessarily provided. In order to verify the effect according to the rest step, the following test was performed.

### Test Target Soil

As the soil contaminated with cadmium, the soil of Type C in which cadmium was present in the contaminated in the form of “ion-exchangeable” was selected as the test target contaminated soil, and the test was performed.

For each of all the prepared samples of the heavy metal contaminated soil, the in situ iron oxide synthesis according to the present invention were performed once and twice. That is, samples subjected to the in situ iron oxide synthesis according to the present invention once and samples subjected to the synthesis twice were prepared, respectively. At this time, the in situ iron oxide synthesis each time was performed a method of injecting FeCl₃·6H₂O into the heavy metal contaminated soil as iron chloride hydrate so that the mass ratio of the Fe injection amount was 1 wt% with respect to 100 wt% of the mass of the heavy metal contaminated soil and injecting NaOH after the injection of FeCl₃·6H₂O so that the pH of the heavy metal contaminated soil was adjusted to 9, that is, in the same form as the method of the in situ iron oxide synthesis of the present invention performed in the other tests before.

In order to examine the influence according to the rest time, the rest time was varied to one hour and 12 hours after the in situ iron oxide synthesis each time. That is, in the case of the sample with the rest time set to 12 hours, while the in situ iron oxide synthesis was performed once or twice, the sample was left for 12 hours (the rest time of 12 hours) after the in situ iron oxide synthesis each time, and then the standard stormwater simulation leaching test was performed. In the case of the sample with the rest time set to one hour, while the in situ iron oxide synthesis was performed once or twice, the sample was left for one hour (the rest time of one hour) after the in situ iron oxide synthesis each time, and then the standard stormwater simulation leaching test was performed. Particularly, in the case of the samples subjected to the in situ iron oxide synthesis once, after the in situ iron oxide synthesis was performed, the samples were left for 12 hours (the rest time of 12 hours) and one hour (the rest time of one hour), respectively, and then the standard stormwater simulation leaching test was performed.

### Test Results and Comparison of Stormwater Leaching Reduction Effects:

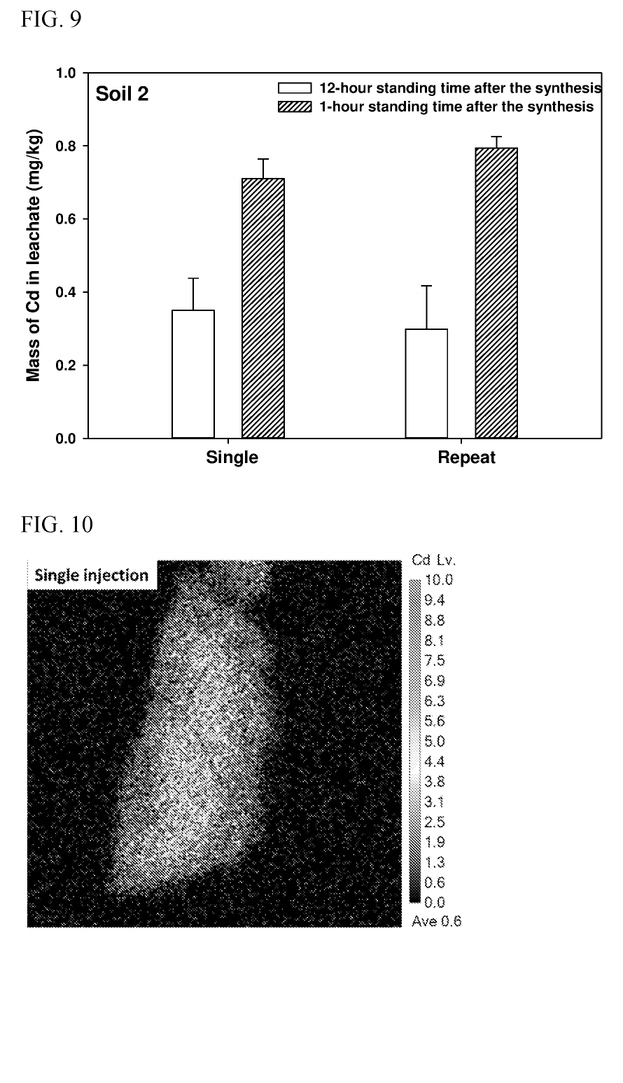

FIGS. 8 and 9 show graph diagrams of cadmium concentrations measured by a USEPA standard Synthetic Precipitation Leaching Procedure as the results of the above test, respectively. Here, Soil 1 of FIG. 8 is a sample in which cadmium in the form of ion-exchangeable was included by 11.9 mg/kg, and Soil 2 of FIG. 9 is a sample in which cadmium in the form of ion-exchangeable was included by 51.3 mg/kg. The vertical axes of the graph diagrams of FIGS. 8 and 9 represent <cadmium concentrations in the leachate mg/kg>, <Single> in the horizontal axes represent “Sample-Single” subjected to the in situ iron oxide synthesis once, and <Repeat> represent “Sample-Repeat” subjected to the in situ iron oxide synthesis twice. Also, the hatched bar graphs in FIGS. 8 and 9 are for the samples that took only the rest time of one hour, and the unhatched bar graphs are for the samples that took the rest time of 12 hours.

As shown in FIG. 8 in Soil 1, in the case of “Sample-Single” subjected to the in situ iron oxide synthesis once, the sample that took the rest time of one hour (indicated by the hatched bar graph in FIG. 8) showed the cadmium stormwater leaching amount of 0.23 mg/kg, and the sample that took the rest time of 12 hours (indicated by the unhatched bar graph in FIG. 8) showed the cadmium stormwater leaching amount of 0.21 mg/kg, whereby there was no significant difference. That is, when the in situ iron oxide synthesis was performed once, the cadmium stormwater leaching amount did not vary significantly depending on the length of the rest time. Meanwhile, in the case of “Sample-Repeat” subjected to the in situ iron oxide synthesis twice, compared with the cadmium stormwater leaching amount of 0.15 mg/kg for the sample that took the rest time of one hour (indicated by the hatched bar graph in FIG. 8), the cadmium stormwater leaching amount for the sample that took the rest time of 12 hours (indicated by the unhatched bar graph in FIG. 8) was 0.08 mg/kg, whereby a significant difference is shown. That is, it was confirmed that, when the in situ iron oxide synthesis was performed twice, a significant difference occurs in the cadmium stormwater leaching amount depending on the length of the rest time.

Meanwhile, in the case of Soil 2, as shown in FIG. 9, in the case of “Sample-Single” subjected to the in situ iron oxide synthesis once, the sample that took the rest time of one hour (indicated by the hatched bar graph in FIG. 9) showed the cadmium stormwater leaching amount of 0.71 mg/kg, and the sample that took the rest time of 12 hours (indicated by the unhatched bar graph in FIG. 9) showed the cadmium stormwater leaching amount of 0.35 mg/kg, which was reduced by almost half. That is, in the case of Soil 2, in the state where the in situ iron oxide synthesis was performed once, there was a significant difference in the cadmium stormwater leaching amount depending on the length of the rest time. Also, in the case of Soil 2, also in the case of “Sample-Repeat” subjected to the in situ iron oxide synthesis twice, the cadmium stormwater leaching amount of the sample that took the rest time of one hour (indicated by the hatched bar graph in FIG. 9) and the cadmium stormwater leaching amount of the sample that took the rest time of 12 hours (indicated by the unhatched bar graph in FIG. 9) showed a significant difference. That is, when the in situ iron oxide synthesis was performed twice on Soil 2, the sample that took the rest time of 12 hours showed the cadmium stormwater leaching amount about 2.7 times lower than that of the sample that took the rest time of one hour. The test results confirm that the configuration of providing the rest time of 12 hours or more between the in situ iron oxide synthesis each time according to the present invention plays a large role and exhibit a great effect in cadmium stormwater leaching reduction.

### 5) Analysis of Cadmium Distribution Form in Generated Iron Oxide

In order to physically verify the effect of the method of heavy metal stabilization in the heavy metal contaminated soil of the present invention, the cadmium distribution states in iron oxide and changes thereof were analyzed for the samples subjected to the in situ iron oxide synthesis of the present invention once and the samples subjected to the synthesis twice.

### Test Target Soil

As sand contaminated with cadmium, a sample in which cadmium was present in the form of “ion-exchangeable” in the sand, and the cadmium concentration in the contaminated soil was 337 mg/kg was selected as the test target contaminated soil, and the test was performed.

As the sample subjected to the in situ iron oxide synthesis once, a sample in which FeCl₃·6H₂O was injected into the heavy metal contaminated soil as iron chloride hydrate, the Fe injection amount was 1 wt% with respect to 100 wt% of the mass of the heavy metal contaminated soil as the mass ratio, NaOH was injected after injection of FeCl₃·6H₂O, and then the pH of the heavy metal contaminated soil was adjusted to 9 (the first in situ iron oxide synthesis was performed) was set as an analysis target. In this case, the in situ iron oxide synthesis was performed once like this, and then the resultant was left for 12 hours (the rest time of 12 hours) so that cadmium in pores was stabilized and then washed with distilled water to collect iron oxide (iron oxide according to the in situ iron oxide synthesis once).

In addition, a sample subjected to the in situ iron oxide synthesis twice was set as an additional analysis target, FeCl₃·6H₂O was injected into the heavy metal contaminated soil as the iron chloride hydrate so that the Fe injection amount was 1 wt% with respect to 100 wt% of the mass of the heavy metal contaminated soil as the mass ratio, NaOH was injected after the injection of FeCl₃·6H₂O so that the pH of the heavy metal contaminated soil was adjusted to 9 (the first in situ iron oxide synthesis was performed), the rest time of 12 hours was taken, the second in situ iron oxide synthesis was performed in the same manner as the first, and the resultant was washed with distilled water, to collect iron oxide (iron oxide according to the in situ iron oxide synthesis twice). For each of the iron oxide according to the in situ iron oxide synthesis once and the iron oxide according to the in situ iron oxide synthesis twice as above, EMPA-EDS was measured, to analyze a heavy metal distribution diagram in the cross-section of iron oxide.

### Test Results and Analysis

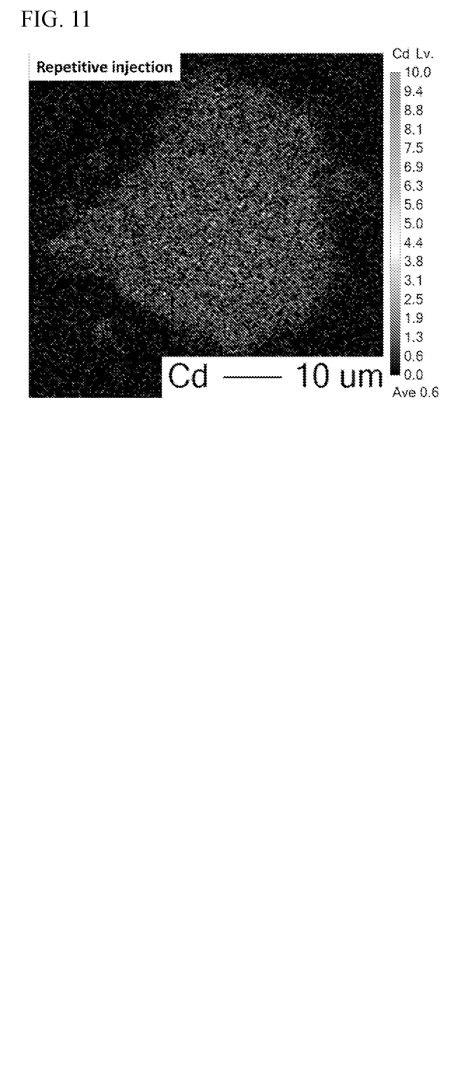

FIG. 10 depicts a distribution diagram of EMPA-EDS measurement results of iron oxide according to the in situ iron oxide synthesis once, and FIG. 11 shows a distribution diagram of EMPA-EDS measurement results of iron oxide according to the in situ iron oxide synthesis twice. As seen with the naked eye in FIG. 10, in the case of iron oxide according to in situ iron oxide synthesis once, cadmium is concentrated in the center of the cross-section of the generated iron oxide. Meanwhile, in the case of iron oxide according to in situ iron oxide synthesis twice, as seen with the naked eye in FIG. 11, cadmium is evenly distributed throughout the cross-section of the generated iron oxide. It is identified that as the in situ iron oxide synthesis of the present invention is repeated, the amount of Fe injected into the soil increases, and accordingly, the result in which cadmium is evenly distributed throughout the cross-section of the generated iron oxide is derived.

In the method of heavy metal stabilization in the heavy metal contaminated soil according to the present invention, the “in situ iron oxide synthesis” in which iron chloride hydrate is injected into the heavy metal contaminated soil, and heavy metals to be stabilized are leached into pores, to generate iron oxide in the heavy metal contaminated soil, is repeated a plurality of times, the in situ iron oxide synthesis is repeated while a predetermined period of rest time is provided between the in situ iron oxide synthesis each time, thereby exhibiting a very excellent heavy metal stormwater leaching reduction effect.

Particularly, in the present invention, when the in situ iron oxide synthesis is performed, iron chloride hydrate is injected into heavy metal contaminated soil, the Fe injection amount is adjusted to be optimum, and further the pH of the heavy metal contaminated soil into which iron chloride hydrate is injected is optimized, thereby an advantage of further maximizing the heavy metal stormwater leaching reduction effect is shown.

What is claimed is:

1. A method of heavy metal stabilization in heavy metal contaminated soil, the method comprising:
a first in situ iron oxide synthesis step in which iron chloride hydrate is injected into the heavy metal contaminated soil to synthesis iron oxide (step S1);
a first rest step for leaving the heavy metal contaminated soil subjected to the first in situ iron oxide synthesis in an equilibrium state (step S2);
a second in situ iron oxide synthesis step in which iron chloride hydrate is injected into the heavy metal contaminated soil to synthesis iron oxide (step S3); and
a second rest step for leaving the heavy metal contaminated soil subjected to the second in situ iron oxide synthesis in an equilibrium state (step S4).

2. The method according to claim 1,
wherein each of the steps for the first and second in situ iron oxide synthesis comprises:
a step for injecting iron chloride hydrate into the heavy metal contaminated soil (step S1-1); and
a step for adjusting a pH of the heavy metal contaminated soil to be 9 or more (step S1-2).

3. The method according to claim 2,
wherein, in the step S1-1, iron chloride hydrate is injected into heavy metal contaminated soil so that an Fe injection amount becomes 1 wt% with respect to 100 wt% of the heavy metal contaminated soil in total, as a mass ratio; and
in the step S1-2, NaOH is injected into heavy metal contaminated soil so that a pH of the heavy metal contaminated soil becomes 9 or more.

4. The method according to claim 1,
wherein, prior to the step S1 is performed, a step for identifying forms of heavy metals in the heavy metal contaminated soil and examining whether heavy metal is present in a form of “ion-exchangeable” in the heavy metal contaminated soil is further performed.

5. The method according to claim 1,
wherein, after the step S4 is performed, the step S1 and the step S2 are repeated multiple times.
